(19) United States
(12) Patent Application Publication
(10) Pub. No.: US 2009/0115109 A1
(43) Pub. Date: May 7, 2009

(54) Method and apparatus for a molded liquid dispenser ice sculture

(76) Inventor: Gregory R. Albright, Lake Elsinore, CA (US)

Correspondence Address: Robert W. Mulcahy, Esq., 520 Sequoia Drive, Sunnyvale, CA, 94086, US

(21) Appl. No.: 12/290,333

(22) Filed: Oct. 29, 2008

Related U.S. Application Data
(60) Provisional application No. 60/985,357, filed on Nov. 5, 2007.

(51) Int. Cl. B29C 39/26; B29C 41/42

(52) U.S. Cl. 264/334; 249/63

(57) ABSTRACT

The invention is directed to an ice mold having a recessed basin element in a predetermined cavity figure and a resilient tubular piece in the form of a sheathed cord running from the basin to a distal exit in the figure, said tubular piece having a pull ring or handle on one end so as to enable physical removal of the cord to form a hollow channel in any predetermined frozen molded sculpture.

This application claims benefit of U.S. Provisional Application No. 60/985,357, filed Nov. 5, 2007, which is hereby incorporated by reference in its entirety.

### BACKGROUND OF THE INVENTION

1. Field of the Invention

This invention relates generally to plastic ice molds and, more particularly, to disposable, single use, ice molds for making relatively large decorative ice figures in the form of liquid dispensers. Ice statuettes for liquid containment and distribution require a liquid repository and an exiting end for cold dispensing of any liquid

2. Description of the Related Art

Currently unitary ice molds are rotationally molded of food safe plastics to form a cavity into which water is poured and then frozen. Generally a gasket or seal is formed about the side wall periphery of the hollow mold in order to free the ice figure from the mold, the sidewall of the one-piece mold being cut or ruptured, by hand, a knife or other instrument. Liquid dispensing ice sculptures require an entrance reservoir and exiting end for containment and distribution of a cooled liquid. The present invention contemplates the preparation of a liquid dispensing ice statue having a liquid reservoir and dispensing end connected by a tubular channel for the liquid flow. There are few unitary mold presently capable of forming such a channeled liquid dispensing ice structure and none of simple construction.

The present invention is directed to a one piece ice figurine mold which has been rotationally molded of food safe plastic to form a cavity into which water is poured and then frozen. The mold has an inner cavity which includes a single piece sidewall substantially surrounding a hollow interior portion thereof, an inner surface of the sidewall being contoured to define the shape of a predetermined figure, and a base wall integrally formed with and enclosing a bottom of the sidewall. The inner cavity is comprised of a reservoir element uniquely structurally channeled to an exit in the sidewall to enable dispensing of cooled liquid from the formed ice figurine. The instant ice mold is an improved structure to enable the formation of a unitary ice liquid dispensing sculpture in a simple and inexpensive manner.

### SUMMARY OF THE INVENTION

The invention resides in a mold for forming liquid dispenser ice figurines which is comprised of a food safe plastic or any other suitable food safe material and includes a single piece sidewall substantially surrounding a hollow interior portion thereof, an inner surface or the sidewall being contoured to define the shape of a predetermined figure, and a contoured base wall integrally formed with and enclosing a bottom of the sidewall. The mold further comprises an aperture or hole for having liquid poured into the interior of the mold and a portion of the sidewall is backfolded to the inner surface to define a hollow rib extending perpendicularly over the sidewall disposed in a manner where it may be severed to expose opposing mold halves. The mold invention resides in a subassembly nested in the predetermined cavity figure comprising a recessed liquid reservoir or basin and a resilient tubular linear string piece in the form of a sheathed cord running from the reservoir to a distal point in the mold figure, said linear tubular piece having a pull ring or handle on one end so as to ultimately enable physical removal of the sheathed tube from the predetermined frozen molded sculpture resulting in a linear liquid flow channel from the liquid containing basin to a distal dispensing end of the ice figure. In this manner liquids can be channeled through the ice sculpture from one point and dispensed, or served, at another point. Additionally, the invention includes relatively large recesses on the base wall extending into the interior of the ice mold so as to form elevated bridge compartments in any ice figurine formations to accommodate light illuminating devices for the ice sculpture.

One embodiment of the mold herein employs a male genital figurine in which the mold formation cavity contains a recessed indentation pan or basin reservoir, a bottom sink portion of which houses a drain plugged with a tubular element string piece extending vertically downward on through the mold figure and distally terminating at the penal end of the male genital end piece of the figure so as to form a liquid flow channel from the liquid pan to the penis head of the genital ice sculpture.

Squarely presented herein is a mold device for forming liquid dispenser ice figurines comprising:
(i) a single piece sidewall substantially surrounding a hollow interior portion thereof, an inner surface of the sidewall being contoured to define the shape of a predetermined figure, a portion of the sidewall being backfolded to the inner surface to define a hollow rib extending perpendicularly over the entire sidewall and disposed in a manner where it may be severed to expose opposing mold halves;
(ii) a recessed basin element in the predetermined cavity figure and a resilient length of tubing in the form of a sheathed linear cord running from a sink in the basin to a distal exit in the figure, said cord piece having a handle so as to enable physical removal of the sheathed cord so as to form a channel in any ice figure formed therein;
(iii) a base portion extending generally horizontally across and enclosing the bottom of the sidewall and having at least one indentation recess for ultimate formation of a base compartment in any mold generated ice sculpture.

Additionally presented herein is a method for preparing a liquid dispensing ice sculpture comprising:
(i) providing a plastic mold having an interior surface with a predetermined shape and a liquid entry means;
(ii) defining a liquid reservoir basin recessed area in the cavity of the mold, said basin having a sink hole plugged with a flexible tubular cord comprised of a linear cylindrical soft metallic material sheathed by a polymeric elastomeric material leading to a distal exit portion of the mold;
(iii) filling the mold with a freezable liquid:
(iv) freezing the enclosed liquid into the predetermined shape of the mold; and
(v) breaking open the mold and removing the tubular cord from the frozen sculpture to form a liquid flow channel from the basin reservoir to the predetermined distal end portion of the ice sculpture.

### BRIEF DESCRIPTION OF THE DRAWINGS

This invention, together with further advantages set forth herein, may best be understood by reference to the following description taken in conjunction with the accompanying sheets of drawings, in the several figures of which like reference numerals identify like elements, and in which:

FIG. 1 is a perspective frontal view of a male ice sculpture mold of the present invention.

FIG. 2 is a sectional side illustration of the ice sculpture mold of FIG. 1 illustrating the structural elements for formation of a liquid dispensing channel in the ultimately formed ice figurine.

FIG. 3 is a perspective side view of the resulting ice sculpture generated by the FIG. 1 mold.

FIG. 4 is a sectional drawing of the sheathed cord element of the instant mold invention.

FIG. 5 is a perspective frontal view of a female torso ice sculpture figurine mold of the present invention.

FIG. 6 is a perspective view of a further embodiment of the female torso of FIG. 5.

FIG. 7 is a side view of the resulting ice sculpture generated by the female torso mold of FIG. 5.

FIG. 8 are two ice sculpture figurines formed from other mold embodiments of the instant invention.

### DETAILED DESCRIPTION OF THE INVENTION

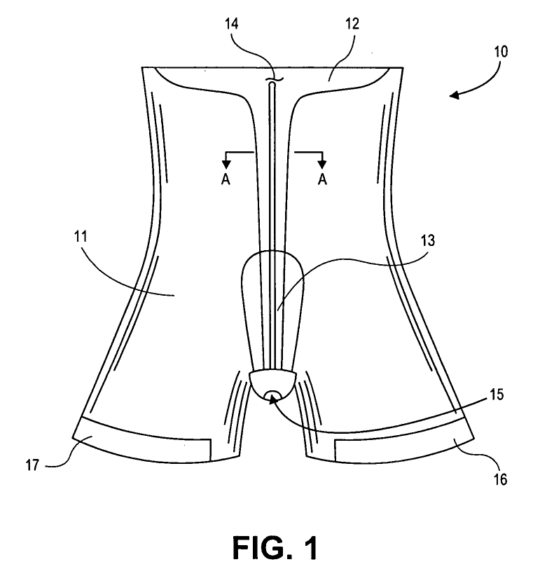

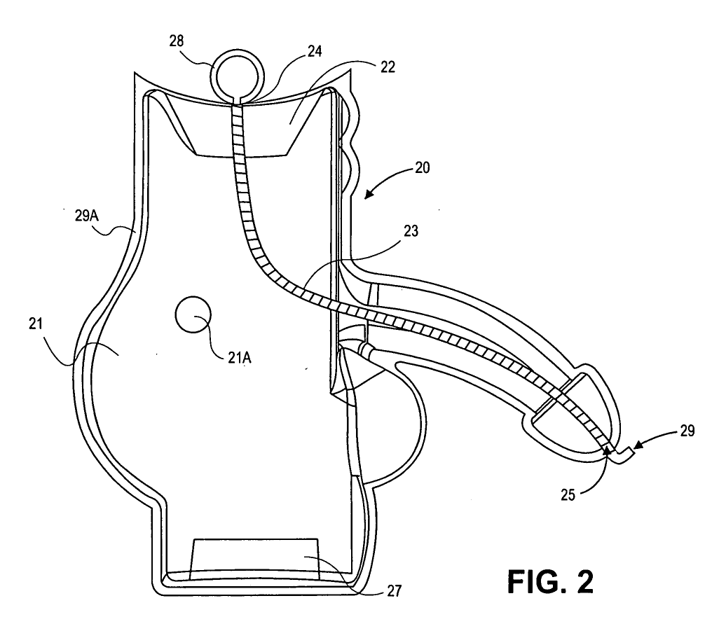

Referring to FIG. 1, a frontal perspective of an ice mold 10 constructed in accordance with the present invention is in the shape of a male torso and genital area and is made of a light polymer exterior, preferably polyvinyl chloride (PVC) plastic. Ice mold 10 is a one piece male genital mold including a penal portion with a channel 13 running through the penis and further includes a sidewall 11, formed in the shape of any figure which the final ice structure is to assume, which sidewall extends around and defines the outside of the ice mold to create a hollow interior therein into which water is poured and cooled. Preferably, the ice mold is formed by rotationally molding the plastic into the desired hollow shape. In the rotational molding operation, an elongate hollow area is formed in each permanent mold half (not shown) adjacent the parting line of the mold halves so as to form a U-shape rib (shown in FIG. 2) around the outside of the sidewall 11. An aperture or hole is provided in the sidewall (shown in FIG. 2) and adapted for having liquid poured through-out the entire interior of the mold.

The invention resides in providing a flexible tubular or string element in the interior of the mold means having an entry and exit configuration through the mold itself and ultimately creating a liquid flow channel in the formed ice sculpture generated by the mold. This is demonstrated in FIG. 1 by the lines designated A-A indicating by way of contrast the interior and exterior of the mold 10 and outlining a depression 12 in the exterior of the mold and a string or wire device in the drawn channel 13 (not shown here but demonstrated as 23 in FIG. 2) of the mold interior, said string or wire device having a handle means (shown as 28 in FIG. 2) at a mold entry point 14, the string extending through the interior of the mold entry and exiting at a distal point in the mold 15, in this case the tip-end of the male genital penis. The function of these mold elements and devices is to cause a depressed liquid basin 12 and a liquid flow channel 13 in the ultimate ice sculpture formed by the mold. Also shown in the base of mold 10 are depressed or concave areas 16 and 17 which replicate recessed compartments in the ultimate ice figurine to hold lights, reflectors, or digital blinkers to generate color or illumination of the ice sculpture.

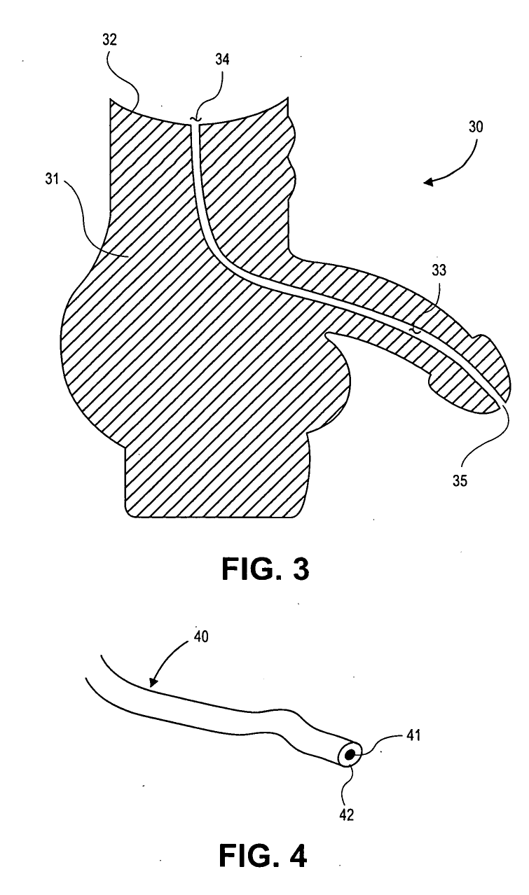

Turning to FIG. 2 there is illustrated a side perspective view of the male genital mold design of FIG. 1 having a sidewall 21 and an open orifice 21a. Dramatically demonstrated is the tubular or string cord piece 23 of the mold 20 commencing at mold entry liquid basin 22 sink point 24 and extending on through the interior of the mold and terminating at distal end 25 of the male genital-penis figure. The cord device 23 is a sheathed cylindrical element and is equipped with a finger ring handle 28 (connected to the central coated wire element, to be explained below in FIG. 4, at the liquid sink entry point 24 and channels on through the penal area and terminates with a perpendicular bend stop 29 at the distal exit end (penis head) of the male genital mold. Shown about the total central side view periphery of mold 20 is an elevated band or rib 29A circumscribing the entire central half of the sidewall 21 wherein the band is the sidewall 21 disposed substantially perpendicularly to an inner surface of the sidewall and is backfolded to define a hollow rib 29A extending over the sidewall at the demonstrated center position where it may be severed to define opposing mold sidewall halves without exposing any other section of the interior of the mold to any severance means. Again repeated here is the illustration of the discontinuity or hole 21A in sidewall 21 into which water may be poured into the interior of the mold and then frozen into a designated sculpture. Briefly, water is poured into the mold 20 through orifice 21A, the mold frozen, the rib cut, the plastic mold disengaged from the formed ice sculpture, and lastly, the tubular cord element 23 removed by pulling it through the ice sculpture by means of the finger ring 28 (connected or affixed to the lead end of the cord 23) thereby resulting in a liquid flow-through channel in the ice figurine. It is to be noted that the bend 29 at the distal end of the penis opening performs the task of securing the cord in its position (no sliding) relative to the entry ring 24 both in the empty mold and upon ice sculpture formation and removal, at which point the bend has to be straightened before removal of the cord by pulling means handle 28. Additionally shown is recessed area 27 which results in a compartment for illuminated devices (not shown) in any ice sculpture formed by the mold.

In FIG. 3 a side view of the liquid dispensing male genital ice figurine 30 formed from the mold of FIGS. 1 & 2 is shown. The channel 33 allows for the passage of liquids from the liquid pan reservoir 32 from the channel entry 34 on through to the distal end 35 at which point the liquid exits. The ice sculpture 30 can be illuminated by lights or other illuminating devices placed in the compartments formed at the base of (not shown in FIG. 3) generated in the ice sculpture structure 30 by depressions 16 and 17 of the mold shown in FIG. 1.

Turning to FIG. 4 there is demonstrated a cutaway view of the flexible cylindrical sheathed cord element 23 of FIG. 2. The sheathed cylindrical cord 40 is constructed of a metal or relatively firm core material 41 surrounded by a flexible elastic sheath covering 42. The firm core material 41 can be any relatively flexible or soft metal such a lead or aluminum or a hard polymeric material such as Polyvinyl Chloride (PVC) or polypropylene and can be in the physical form of a wire or cylindrical tubular structure such as a solid elastomeric tubing. The sheath 42 can be any material which is physically softer than the central core 41 and preferably an elastomeric material such as a styrene-butadiene copolymer. The very essence of the instant invention lies in the same string chord element shown in FIG. 2 (as legend 23) which functions to occupy space in the mold cavity thereby causing the formation of a channel from one entry point to a distal end exit point in any formed ice sculpture. This is best demonstrated in FIG. 2 where water in introduced into port 21A filling the cavity and the mold 20 and its aqueous contents are then frozen thereby trapping the sheathed cord element 23 in a defined channel of the formed ice sculpture. When the rib 29A is cut and the sidewall skin is removed and discarded, there remains the ice figurine in the form of a male genital design having an embedded sheathed chord 23 with an exposed ring 28 and a bent cord at the distal penis end of the ice figure. The exposed bent chord is straightened and a pulling force applied (see legend 28 of FIG. 2) to remove the metallic center cord from its ice encasement thereby leaving a liquid channel in the male genital design as seen in legend 33 of FIG. 3. The elastomeric layer may be formed of any elastomeric material (elastic rubber or elastomer) such as urethane rubber, butyl rubber, fluorocarbon rubber, or acrylic rubber, including any elastomeric styrene or styrene copolymer resins.

The removal of the sheathed chord from the ice figures form by the instant mold shown in FIGS. 1 and 2 is a two step process and a critical feature of the instant mold invention. Because the sheathed cord of the embodiments of FIGS. 1 & 2 is comprised of a metallic core, ringed at one end and bent at the other, applying a pulling force on the ring (an extension of the metallic core of the cord), smoothly and separately removes the metallic core (see 41 of FIG. 4) both from the mold and the overlaying sheath in which it was wrapped. The sheath itself being disengaged from the removed center cord (see 41 of FIG. 4) becomes thinner and softer (having reduced force on its circumference due to the removed core) and more easily removed; that is, the reduced area of the disassembled cord causes facile removal of the elastic sheath. The instant sheathed cord enables separate and facile removal of the composite parts of the cord without disturbance to the ice structure. It is this feature of the instant sheathed chord that pervades all the embodiments and renders the instant ice molds facile and efficient in the formation of ultimate liquid dispensing ice figurines.

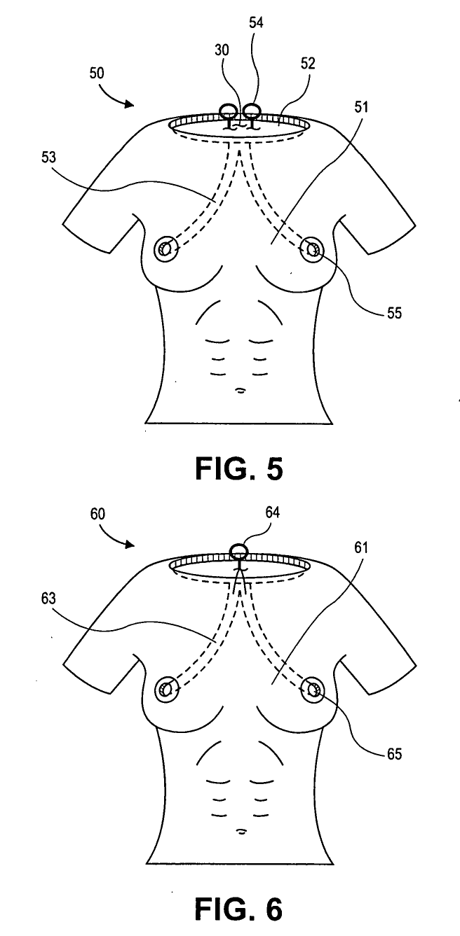

Another mold structure and its corresponding ice sculpture are demonstrated in FIGS. 5 and 6 where the design is of a female torso. FIG. 5 illustrates the female breast structure 50 having bare breasts 51 which will operate as liquid dispensing sites much in the same manner as the penis element of FIGS. 1-3. The liquid reservoir or beverage basin 52 is located in the torso neck area and has two separately ringed sheathed cords (the cords not shown) with the shown attached rings 54 commencing at drain entrances (below the rings and not shown) and continuing down the dotted line channels shown as 53, each sheathed chord exiting at the breast nipples as the distal end of a connection to the liquid reservoir so as to form a channel in any ultimately formed breast ice sculpture. While not shown in this FIG. 5, the sheathed chords terminate at each nipple 55 and are in a bent configuration much in the same manner shown for the male mold sculpture 10 (specifically legend 29 in FIG. 2. The function of a female mold operates in the same manner as that described for the male mold and ice sculpture above except that each sheath cord ring 54 must be actuated separately by pulling the respective ring from any frozen sculpture formed in the female mold. The sheathed channel cords are purposely separated because the female sculpture is largely a party item and separate distribution of liquid through the female nipples may be desirable for any users. Another female ice figurine in shown in FIG. 6 where the sheathed chords are joined to form a bifurcated channel 63, connected by one ring 64 and so pulling of this ring in any generated female ice sculpture will remove both chords forming bifurcated channels 63 and cause concurrent distribution of liquid poured into the formed basin (see 52 of FIG. 5) through the ice breast channels 63.

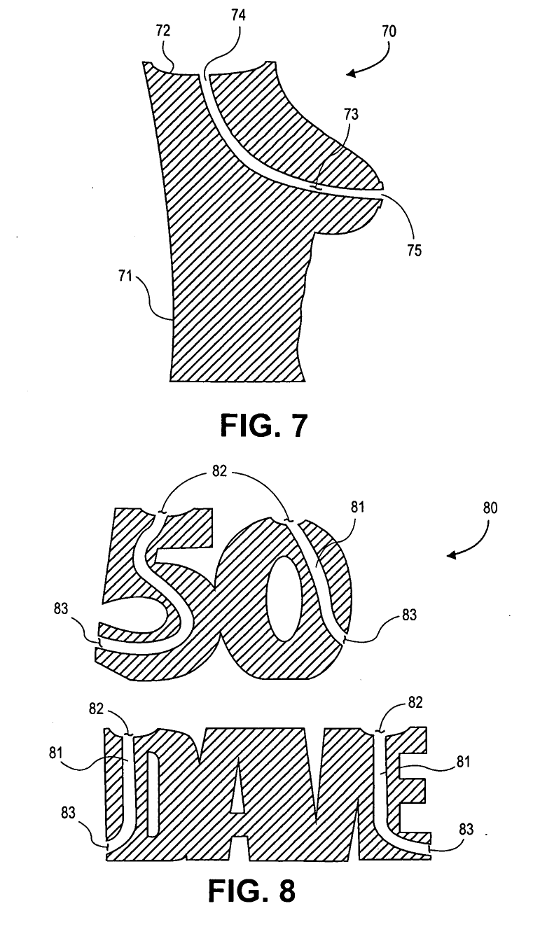

FIG. 7 illustrates a side perspective of the female ice sculpture 70 formed from the torso mold of FIG. 5 and is functionally comparable to the male ice sculpture of FIG. 3. The liquid basin 72 feeds the entry mouth 74 of the sheathed-cord formed channel 73 exiting at the distal nipple end 75 of single breast of the female ice figurine 71.

The structures shown in FIGS. 1-7 are party oriented male and female anatomical ice mold structures. However, it will be understood that the shape of the ice mold of the instant invention is limited only by the imagination of the mold designer and the facile formation of liquid channels through any conceived ice figurine using the instant functional sheath chord mechanism. The instant invention facilitates that liquid channel formation in any ice sculpture. Such facilitation is demonstrated in FIG. 8 which show two different simple ice formations 80: one to the numeral “50” and the other to a male name “DAVE”. Each of these ice statuettes 80 demonstrates two liquid channels designated as 81 along with entries 82 and exit portions 83 to convey cooled liquids during use. These statuettes would employ the mold construction with its sheathed-cord element and mechanism to arrive at the ice figurines shown.

To recapitulate, the instant ice mold invention herein centers around the use of a linear string or tubular piece of sufficient circumference extending from a recessed portion onto a distal termination end of the mold so as to be readily removable thereby forming an entry and exit flow channel in any ice figurine formation. It is within the purview of the instant invention to use a large circumferential gauge wire to generate channel formation in the ice figurine formed by the molds of the instant invention. Another choice would be a solid elastomeric tubing which would form a channel in the ice sculpture and be easily removable as an elastic structure. The linear tubular, channel forming arrangement can be any device to cause the channel formation function but is preferably an elastic sheathed cord as demonstrated herein.

Having thus described the principals of the invention, together with illustrative embodiments thereof, it is to be understood that although specific terms are employed, they are used in a generic and descriptive sense and not for the purpose of limitation, the scope of the invention being set forth in the following claims.

What is claimed:

1) A mold for forming liquid dispenser ice figurines comprising:
(i) a single piece plastic sidewall substantially surrounding a hollow interior portion thereof, an inner surface of the sidewall being contoured to define the shape of a predetermined figure, a portion of the sidewall being backfolded to the inner surface to define a hollow rib extending perpendicularly over the entire sidewall and disposed in a manner where it may be severed to expose opposing mold halves;
(ii) a recessed basin element in the predetermined cavity figure and a resilient length of a flexible linear string cord element running from a sink in the basin to a distal exit in the figure, said linear piece having a handle means so as to enable physical removal of the linear cord so as to form a channel in any ice figure formed therein;
(iii) a base portion extending generally horizontally across and enclosing the bottom of the sidewall and having at least one indentation recess for ultimate formation of a base compartment in any mold generated ice sculpture.

2) The mold of claim 1 wherein the linear string element is in the form of a tubular sheathed cord.

3) The mold of claim 3 wherein the tubular string element is a flexible sheathed cord comprised of metallic core center coated with a soft resin sheathing material.

4) The mold of claim 1 wherein the plastic materials of the mold is selected from the group of polyethylene, polypropylene, polyvinyl chloride polymers and mixtures thereof.

5) The mold of claim 4 wherein the mold is comprised of polyvinyl chloride and the soft resin material sheathing of the tubing is an elastomeric material.

6) The mold of claim 5 wherein the elastomeric material is a styrene copolymer resin.

7) The mold of claim 5 wherein the tubing additionally comprises at least one pull handle means attached to the metal core of the sheathed tubing at the basin sink entry point for facile removal of the tubing and formation of a liquid flow channel in any formed ice sculpture figure of the mold.

8) The mold of claim 7 wherein the tubing is unitarily connected at the tube entry sink of the basin with a single pull handle element and bifurcated to form two separate liquid channel paths each terminating and exiting at different distal points of the mold.

9) The mold of claim 8 wherein there are two separate unconnected strands of tubing each with a separate pull handle in the basin sink and each forming a separate channel path to different distal points in the mold.

10) In a one piece disposable ice sculpture mold comprised of plastic material and an inner cavity in the shape of a predetermined figure and having an opening for entry of a freezable liquid;
an improvement comprising:
i) a recessed basin and sink as part of the predetermined figure and at least on length of removable tubing running from the basin sink entry point to at least one other distal end of the mold figure to form at least one liquid flow channel from the basin to at least on distal exit point in any ice figurine generated by the mold.

11) The mold of claim 10 wherein the removable tubing is in the form of a sheathed linear cord.

12) The mold of claim 1 wherein the tubing is a flexible sheathed cord comprised of metallic core center coated with a soft resin material sheathing.

13) The mold of claim 12 wherein the plastic materials of the mold is selected from the group of polyethylene, polypropylene, polyvinyl chloride polymers and mixtures thereof.

14) The mold of claim 13 wherein the mold is comprised of polyvinyl chloride and the soft resin material sheathing of the tubing is an elastomer.

15) The mold of claim 14 wherein the elastomeric material is a styrene copolymer resin.

16) The mold of claim 14 wherein the tubing additionally comprises at least one pull handle means attached to the metal core of the sheathed tubing at the basin sink entry point for facile removal of the tubing and formation of a liquid flow channel in any formed ice sculpture figure of the mold.

17) The mold of claim 16 wherein the tubing is unitarily connected at the tube entry sink of the basin with a single pull handle element and bifurcated to form two separate liquid channel paths each terminating and exiting at different distal points of the mold.

18) The mold of claim 17 wherein there are two separate unconnected strands of tubing each with a separate pull handle in the basin sink and each forming a separate channel path to different distal points in the mold.

19) A method of making ice sculptures comprising:
i) providing the ice mold of claim 3:
ii) placing the entire assembly in a cold environment to cause freezing of the water and formation of a predetermined ice figure;
iii) cutting the hollow rib to expose each half of the mold;
iv) separating the sidewall from the ice surface and generating an integral ice sculpture containing the exposed handle for the length of tubing running from the basin to the distal exit end of the formed ice sculpture; and
v) applying pulling force to the tube handle to remove the metallic core center whereby the emptied flexible sheathing is softened and removed by hand thereby generating a liquid dispensing ice figurine.

20) The method of claim 19 wherein there are at least two flexible sheathed cords, each with a separate handle in the basin sink and separate pulling force applications are applied to form separate liquid floe channels in the ice sculptures.
